(19) United States
(12) Patent Application Publication
(10) Pub. No.: US 2007/0074027 A1
(43) Pub. Date: Mar. 29, 2007

(54) Methods of verifying, signing, encrypting, and decrypting data and file

(76) Inventor: Tien-Chun Tung, Taipei City (TW)

Correspondence Address: TIEN-CHUN TUNG, apt 3D, 3620 168th St., Flushing, NY, 11358, US

(21) Appl. No.: 11/234,524

(22) Filed: Sep. 26, 2005

(51) Int. Cl. H04L 9/00

(52) U.S. Cl. 713/176

(57) ABSTRACT

Methods of verifying, signing, encrypting and decrypting data and files contained a mobile telecommunication device having public keys (authentication) and private keys (digital identification) installed inside the device, and an electronic device handling requests to the mobile telecommunication device. When the files are signed, verified, encrypted or decrypted, the electronic device is input (or automatically connected) with an identification code and then requests are sent for verification, signing, encryption and decryption together with certain optional necessary data to the mobile telecommunication device. According to various requests, the mobile telecommunication device releases the installed public keys or obtains private keys by inputting pre-set protective access codes to sign, verify, encrypt, or decrypt to the necessary data and then re-transmit the signed, verified, encrypted or decrypted necessary data to the electronic device to complete the methods. By using the mobile telecommunication to sign, verify, encrypt and decrypt the data and files, methods of identification are cost saving and conveniently to be used.

### BACKGROUND OF THE INVENTION

1. Field of the Invention

The present invention relates to methods of verifying, signing, encrypting, and decrypting data and file. More particularly, the methods related to authenticate, sign, encrypt, decrypt the data and file with easy-to-use and cost-saving ways.

2. Description of Related Art

According to a search report of CommerceNet, the main obstacles of electronic business are security and encryption problems. In order to give impetus to electronic transaction in popularity and make sure the safety of Internet trade, countries worldwide have legislated electronic signature bills to make the electronic signatures and files legal-effective and have constructed public key infrastructure (PKI) to achieve safety requirement such as source identification of file transmission, files privacy, files completion and Non-Repudiation for internet trade.

Every user in PKI mechanism has a public key that is accessible by others, and a private key that is kept by the user. A message sender (the user) uses the private key to stamp a digital signature, and a message receiver verifies the digital signature with the public key of the sender. However, owners of the public keys cannot be verified or identified so that a just certification authority (CA) is in charge of keeping the public keys and to verify the owners' identities. The certification authority issues an electronic certification of the public key to each end-entity (the certification comprises a serial number, the public key of the end-entity, identification of the owner, effective period (start date and expire date), the name of the certification authority and a digital signature) and provides certificating services to verify the end-entity and the public key.

In the present technology, the private key is saved in a hard disk or in a soft disk of a computer, a hardware specific module (HSM), a smart card, a token or other practicable saving element. However, these methods for saving the private keys have the following drawbacks:

1. High Cost

The private keys are saved in the hard disk or in the soft disk of computer, the hardware specific module (HSM), the smart card, the token or the other practicable saving element, the user has to buy one of those accessories, as a result, the operation cost is increased.

Also, solely rely on CAs to keep the public keys will result the complication on the security system and the extra cost to users.

2. Inconvenience in Use

When the user goes out and needs to authenticate, sign, encrypt or decrypt certain data and file, the user must first find a computer with Internet access; and then user must find a computer system that can access the user's digital ID in certain way. Carry those gears and make sure they work correctly in various environment is cumbersome.

3. Security Infringement

Once the private key is stolen or is exposed to the public, some evil-minded speculators would use the private key for illegitimate/ unlawful activities. As the private key represents the digital ID of the user so that the user would be involved in troubles or even become the scapegoat when the illegal actions are investigated.

In consideration of the drawbacks of the method of verifying, signing, encrypting and decrypting, the present invention provides a simplified and improved method to obviate the aforementioned problems.

### SUMMARY OF THE INVENTION

One of main objectives of the invention is to provide a method of verifying, signing, encrypting and decrypting data and file. it is an object of the present invention to provide a method that is cost-saving.

Another objective of the invention is to provide a method of verifying, signing, encrypting and decrypting data/file, thus the method is convenient in use.

It is another object of the present invention to provide a method of verifying, signing, encrypting and decrypting data and files, wherein the method can verify identification of the user regardless of the geographical location of the user.

In order to achieve the foregoing objectives, the method comprising steps of:
inputting an identified number of a mobile device into an electronic device having the data or the file to be authenticated, signed, encrypted, or decrypted; (or the mobile communication device and electronic device may be communicated with each other directly when they are in close proximity.)
the electronic device transmits requests with optional “Necessary Data” to the mobile communication device, which confirms the requests and either (1) sends back a public key—and keep the public key in the mobile communication device, to the electronic device for verifying or encrypting; or (2) prompts the user to enters a pre-set access code to obtain a private key kept in the mobile device for signing or decrypting the “Necessary Data” passed, and then sending back the processed “Necessary Data” back to the electronic device to complete the signing or decrypting of the data/file in the electronic device.
Depending on user's choices, it may not be necessary to enter access codes to retrieve the private key; or the user may wish to keep the private key available for certain amount of time after entering the access code. Subsequent uses of the private key within this specified amount of time can be authorized automatically without entering the access code.
By using the mobile device to verify, sign, encrypt and decrypt the data/files, the user does not need to purchase other accessory to keep the public and private keys or to ensure their public or private key can be retrieved correctly under different working environments. The user can do the verification, signing, encryption or decryption to the data or the files anywhere in the world as long as the mobile telecommunication device can be used. Moreover, since each mobile telecommunication device has a unique identification code or a number (for example: the mobile phone number) that assigns to the corresponding mobile telecommunication device, therefore this improved invention can be used to further improve the authentication.

Additionally, this invention can skip the certification authority in some applications because the public key and the private key are stored in the mobile telecommunication device and be kept by the owner. Any person who can be contacted by the mobile telecommunication device (such as mobile phone), can use the mobile telecommunication device to verify, sign, encrypt, or decrypt data/files worldwide without relying on other “Certificate Authorities”.

The invention provides a simply, easy, and reliable method to allow the exchange of signed or encrypted data and files—even among unacquainted people. If necessary, user can simply contact the mobile telecommunication device (such as making a call to a mobile phone) to confirm a person's identity.

By using the existing framework of the mobile telecommunication devices and storing the public and private keys store in the mobile communication device, users can securely exchange data/files among each other with the capabilities of signing, verifying, encrypting, or decrypting the data/files worldwide. Thereby, security of electronic transmission is improved, and the procedures of identifying the users are also simplified to save cost.

Other objects, advantages and novel features of the invention will become more apparent from the following detailed description when taken in conjunction with the accompanying drawings.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the descriptions, serve to explain the principles of the invention. In the drawings,

FIG. 1 is a schematic diagram showing concepts of methods of verifying, signing, encrypting and decrypting data and/files in accordance with the present invention;

FIG. 2 is a schematic diagram showing connections between elements in the methods of the present invention;

FIG. 3 is a schematic diagram of a preferred applicable system in accordance with the methods of the present invention;

FIG. 4 is a data flow diagram showing procedures of creating a public key and a private key;

FIG. 5 is a data flow diagram showing procedures of signing in a mobile telecommunication device;

FIG. 6 is a data flow diagram showing procedures of verifying signatures in the mobile telecommunication device;

FIG. 7 is a data flow diagram showing procedures of signing in an electronic device;

FIG. 8 is a data flow diagram showing procedures of verifying signatures in the electronic device;

FIG. 9 is a data flow diagram showing procedures of encrypting in the electronic device; and

FIG. 10 is a data flow diagram showing procedures of decrypting in the electronic device.

### DETAILED DESCRIPTION OF PREFERRED EMBODIMENT

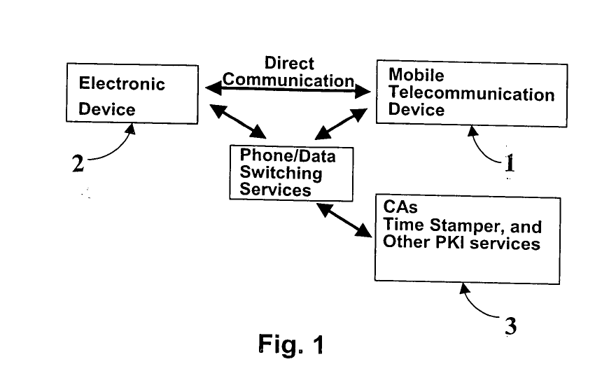

With reference to FIG. 1 that is a schematic diagram showing a concept of methods of verifying, signing, encrypting and decrypting data and files in accordance with a preferred example of the present invention, the concept of the methods is to connect an electronic device 2 with a mobile telecommunication device 1. Then, the electronic device 2 sends requests (and optionally with “Necessary Data”) for verification, signing, encryption or decryption of the data and files to the mobile telecommunication device 1. According to the requests, the mobile telecommunication device 1 releases a public key or sends the “Necessary Data” back to the electronic device 2 after verifying, signing, encrypting or decrypting. Lastly, the electronic device 2 completes the verification, signing, encryption and decryption to the files. In those methods, no private key is stored in the electronic device 2 so that an illegal access of the private key is thus avoided. Wherein, the mobile telecommunication device 1 can be a mobile electronic equipment having a specific identification code or a number (may be a name or a set of identification numbers that uniquely identify the mobile electronic equipment) to permit communication, such as a cell phone etc. The mobile electronic equipment contains the public key (authentication), the private key (digital ID) and the necessary procedure programs for verifying, signing, encrypting and decrypting data and files. The mobile telecommunication device 1 only releases the public key or signs, verifies, encrypts or decrypts the necessary data transmitted from the electronic device 2. The electronic device 2 is an operational application system (or an element in part of the application system) such as a computer, a printer, a cash register, a cell phone or the other similar equipments. The electronic device 2 has original data and files that need to be verified, signed, encrypted and decrypted. The electronic device 2 can directly or indirectly connect to one or multiple mobile telecommunication devices 1 to send the requests of verification, signing, encryption and decryption, and lastly the system completes the verification, signing encryption and decryption to the data/files. However, the cell phone can be either the mobile telecommunication device 1 or the electronic device 2 selectively. The data/files can be the information with any content, code, formation or size and are those objects that need to be verified, signed, encrypted or decrypted. The necessary data are data transmitted between the mobile telecommunication device 1 and the electronic device 2 and can be plain data, digest data, cipher data, or codes, wherein the content of the necessary data is determined by different application embodiments.

Additionally, the mobile telecommunication device 1 may cooperate with certification authority, time-stamping server or other public key infrastructure (PKI) to support secure Internet transactions among the electronic device 2.

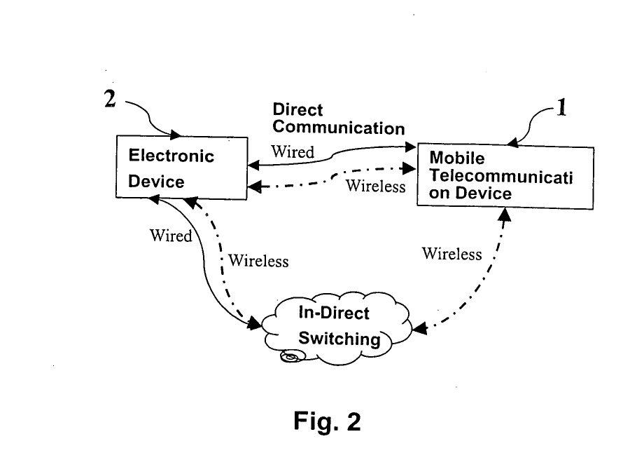

With reference to FIG. 2 that shows a diagram for communication between the devices, connections between the mobile telecommunication device 1 and the electronic device 2 are wired (various networks or signal cables) or wireless (infrared, blue tooth, or other methods) to achieve a direct transmission. Moreover, the mobile telecommunication device 1 selectively and indirectly connects to the electronic device 2 with an intermediate transmission (a hand-over, switching, or other similar services) by using the identification code. The intermediate transmission can be wired, wireless or a combination of both to connect the mobile telecommunication device 1 and the electronic device 2.

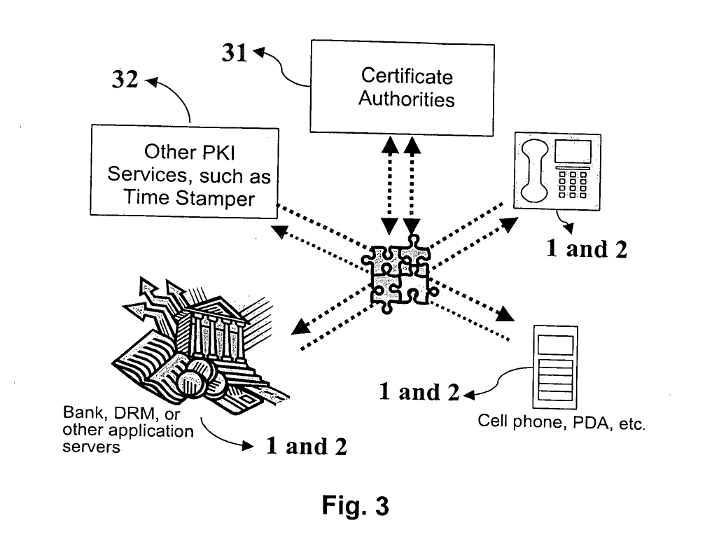

With reference to FIG. 3 that is a schematic diagram of another system embodiment of the present invention, this system embodiment comprises a mobile telecommunication device 1, such as a cell phone belonged to a customer, a time-stamping service system 31 and one or multiple certification authorities (or other services required by PKI system) 32. When the customer purchases products, cell phone number of the customer is input into the cash register representing a seller. Then, the cash register transmits a transaction bill with a signature of the seller to the mobile telecommunication device 1 to make the customer verify the transaction bill. After checking, the customer signs the transaction and sends to a bank to permit the payment from a specific account in the bank. Once the bank verifies the signatures from the customer and the seller, the bank then charge the service fees according. Lastly, the bank signs the transaction and sends back to the cash register (the seller) to complete the process. During the transaction, the customer only needs to input the cell phone number without using any credit card. This system embodiment may need various PKI services such as the time-stamping service system and the certification authorities (keeping public key certifications of the customer, the seller and the bank) to make the transaction practicable. It is also obviously that this system allows multiple signing parties during the transaction, such as a company payment, which may have many persons involved in signing a bill.

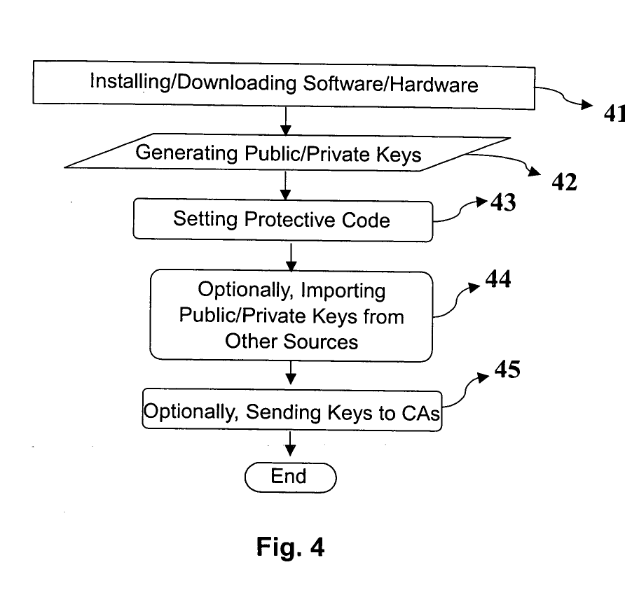

With reference to FIG. 4 that is a diagram of creating the public key and the private key, the user needs some preparations before using the mobile telecommunication device to verify, sign, encrypt or decrypt. The preparations comprise:

installing (or downloading) a software (hardware) to the mobile telecommunication device 1, wherein the software (hardware) is generated and kept the public and private keys 41;

generating the public and private keys 42;

setting a protective access code to prevent the private key from an illegal access 43 (optionally, setting the time for keeping private key in memory); and

optionally sending the public key to certain certification authority 44

Selectively, the mobile telecommunication device has one or more sets of the private and public keys in pairs. Moreover, the public and private keys in this invention can be transmitted into the mobile telecommunication device from exterior.

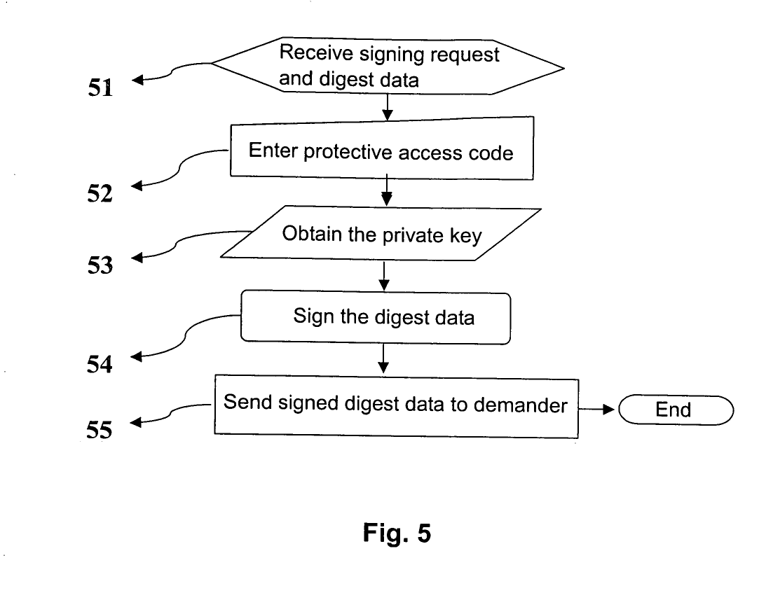

With reference to FIG. 5 that is a diagram of a signing method with the mobile telecommunication device, procedures of the signing method comprise:

inputting a protective code 52 to the mobile telecommunication device when the mobile telecommunication device receives a digest data 51;

obtaining the private key in the mobile telecommunication device 53;

signing the digest data with the private key 54;

sending the signed digest data to a demander 55; and

completing the singing by the private key in the mobile telecommunication device 1.

Wherein the digest data is a data derivative from the data/ or the files, such as a data digest. The digest data is a set of numbers that can be calculated or concluded with arithmetic such as Message Digest (MD5), Secure Hash Algorithm I (SHAI) or other Hash algorithm systems. When the files change, the digest is correspondingly changed.

The protective access code is a set of personal numbers or alphabets determined by the owner of the private key to prevent the private key from illegal access. Even if the mobile telecommunication device is lost, the private key is still kept in secret without knowing the protective access code.

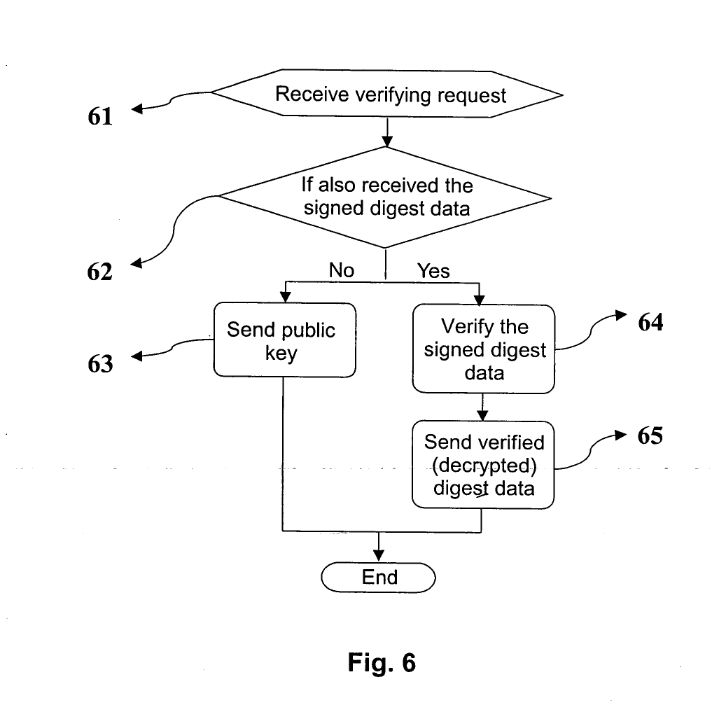

With reference to FIG. 6 that is a flow diagram of a verifying method with the mobile telecommunication device, the procedures of the verifying method comprise:

receiving request from the electronic device for verifying a signature 61;

confirming receipt of the signed digest data 62;

selectively sending the public key to the demander if the receipt confirmation is negative (or confirm before sending the public key) 63;

selectively confirming validity of the singed the digest data with the public key in the mobile telecommunication device if the receipt confirmation is positive 64; and

sending the decrypted digest data back to the demander after confirming 65.

Thereby, the procedures of the verifying a signature method are achieved.

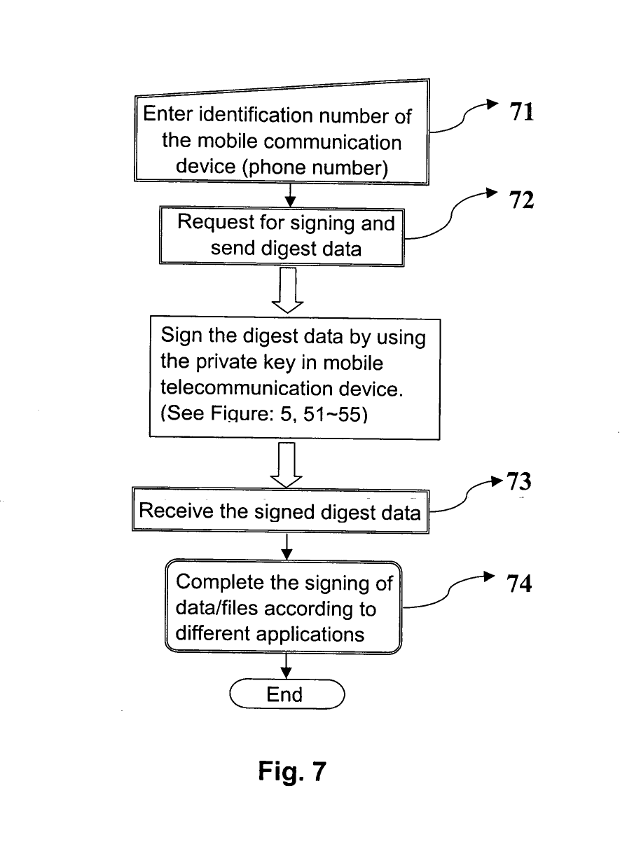

With reference to FIG. 7 that is a flow diagram of a method of signing data/files in the electronic device, procedures of this method comprise:

inputting an identification code of the mobile telecommunication device of the signer (or the demander optionally) to the electronic device 71;

transmitting the digest data of the data and files to the mobile telecommunication device of the signer to request signing 72;

signing in the mobile telecommunication device; (the procedures of signing in the mobile telecommunication device are previously mentioned in description of FIG. 5, (51-55), redundant description is obviated here);

receiving the signed digest data sent from the mobile telecommunication device 73; and

completing the signing of the data and files by using the signed digest data received in previous step with proper methods according to the application system in reality. 74.

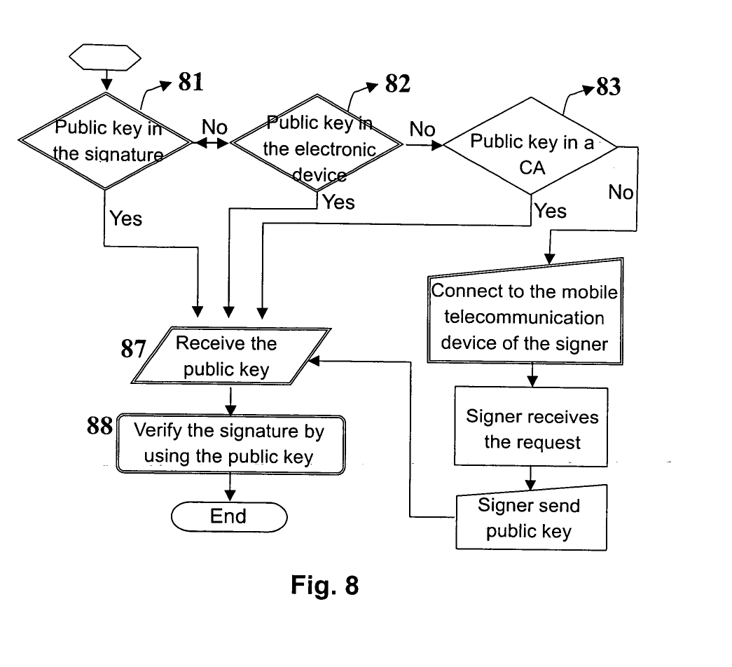

With reference to FIG. 8 that is a flow diagram of a method for verifying the validity of the signing in the electronic device, procedures comprise:

confirming whether the public key is contained in signed data in the data and files 81;

if the result is negative (NO), confirming whether the public key is saved in the electronic device 82;

if the result is negative (NO), confirming whether the public key is saved in the designated certification authority 83;

if the result is negative (NO), inputting the set of identification numbers of the mobile telecommunication device belonged to the public key owner, and making the connection in order to send requests, optionally with the signed digest data. 84 (the system may automatically call the mobile telecommunication device in accordance with the information in the signed data);

the mobile telecommunication device receives the request of verifying signature 85, and optionally with signed digest data; (the procedures of verifying signature in the mobile telecommunication device are previously mentioned in description of FIG. 6, (61-65), redundant description is obviated here);

mobile telecommunication device sending the public key with permission of the owner of the public key 86 (or selectively automatically sending the public key) to the electronic device;

checking validity of the signing in the data and files by using the public key 88 after the electronic device receives the public key 87.

Thereby, the procedures of verifying a validity of the signing in the files are achieved.

Additionally, the public key is selectively obtained by various sources such as the public key contained in the signed files, the public key saved in the electronic device, the public key kept in the designated certification authority or the public key obtained from the mobile telecommunication device of the signer. Then, the public key is used to verify the validity of the signing.

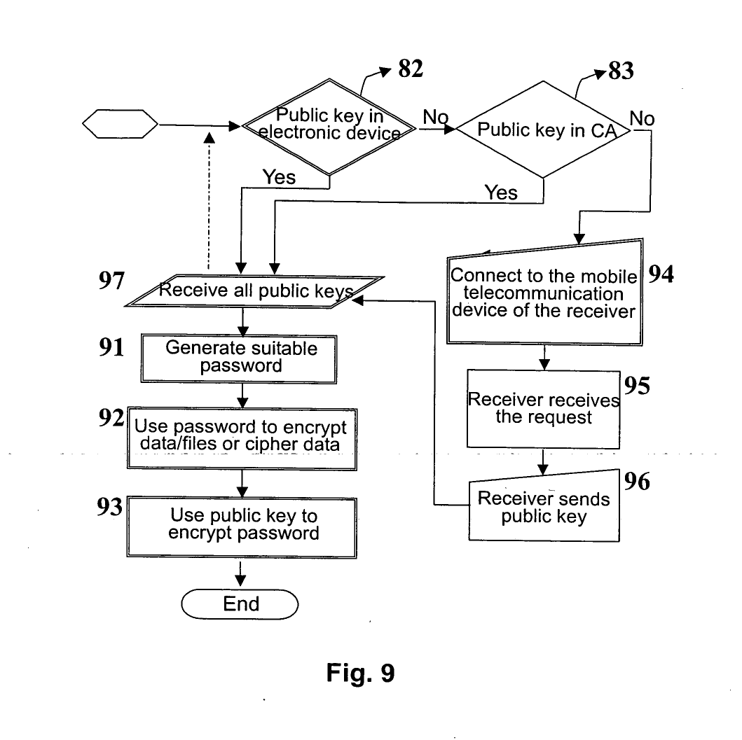

With reference to FIG. 9 showing an encryption method of the data and files in the electronic device for specific receivers, the public keys are obtained from the receivers (multiple receivers in some cases) and then used to encrypt the data and files. Procedures of the encryption method with multiple receivers comprise:

confirming whether the one public key is available in the electronic device 82;

if the result is negative (NO), confirming whether the public key is available from a certification authority 83;

if the result is negative (NO), inputting the set of identification numbers of the mobile telecommunication device belonged to the public key owner and make the connection to send request for public key. 94

the mobile telecommunication device receives the request of sending public key. 95;

mobile telecommunication device sending the public key with permission of the owner of the public key 96 (or selectively automatically sending the public key) to the electronic device;

collecting all necessary public keys of the data and files receivers in the electronic device 97; (repeating the foregoing steps until the public keys of the multiple receivers are all obtained)

creating a adequate password 91 to encrypt the data and files or to encrypt certain application dependent cipher data 92; and

using the public key of each receiver to encrypt the password.

Thereby, the procedures of encryption data/files method are achieved.

Wherein, the password is randomly generated by corresponding encryption algorithm in order to directly encrypt the files or to encrypt certain application dependent cipher data. Then, the public key of the receiver is used to encrypt the password. The encrypted password, public key properties, and optionally the encrypted application-dependent cipher data are combined with the data and files. Additionally, multiple encrypted passwords are generated if there are multiple receivers for the data and files. The cipher data are decided by the real application system. For example, the cipher data maybe the encryption seed and segments of the data and files defined by the application system. The password is a randomly generated by some specific algorithm methods (such as Triple Data Encryption Standard (Triple-DES), Rivest Cipher 2 (RC2) or Advanced Encryption Standard (AES) etc.) to encrypt the data and files or the cipher data.

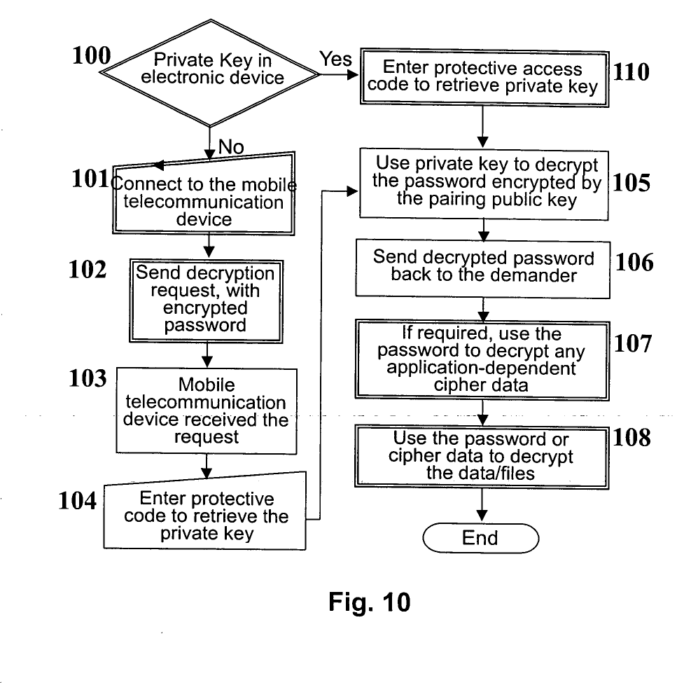

With reference to FIG. 10 showing the decryption of the files in the electronic device, decryption is achieved by using the private key to decrypt the password encrypted by the pairing public key, and then the decrypted password is utilized to decrypt the data and files (or decrypt the cipher data of the data and files). Usually, the properties of the public key (certificate) are designated in accordance with the location of the corresponding private key. Procedures of decryption method comprise:

confirming whether the matched private key is available in the electronic device 100;

if the result is positive (YES), inputting the protective access code to obtain the private key 110 that is used to decrypt the password encrypted by the matched public key 105;

if the result is negative (NO), inputting the set of identification numbers of the mobile telecommunication device (which contains the matched private key) to the electronic device. (If the properties of the public key contains an connection method, the electronic device may automatically communicates with the mobile telecommunication device) 101;

sending a decryption request and the password encrypted by the matched public key 102;

inputting the protective code to the mobile telecommunication device in order to obtain the private key 104;

using the private key to-decrypt the password encrypted by the matched public key 105;

sending back the decrypted password to the electronic device 106;

selectively decrypting the application dependent cipher data with the password if required by the application system 107; and

depending on the application, decrypting the data and files with the decrypted password or cipher data. 108.

Thereby, the procedures of encryption the files are achieved 109.

Real embodiments for decrypting the files are decided by the application system, for example, using the password or obtaining the encryption seeds from the cipher data to encrypt the files.

In summary, the present invention is operable and innovative and improves the drawbacks of the conventional method for safety of Internet transaction.

Even though numerous characteristics and advantages of the present invention have been set forth in the foregoing description, the embodiments are illustrative only. Changes may be made in detail, especially in equivalent substitution or modification within the principles of the invention to the full extent indicated by the broad general meaning of the terms in which the appended claims are expressed.

What is claimed is:

1. A method for signing, verifying, encrypting and decrypting data and files, the method comprising:
installing a software or a hardware in a mobile telecommunication device;
generating a public key and a private key by the software or hardware in the mobile telecommunication device; and
using the public key and the private key stored in the mobile telecommunication device to sign, verify, encrypt and decrypt the data and files.

2. The method for signing, verifying, encrypting and decrypting data and files as claimed in claim 1, wherein the mobile telecommunication device is a cell phone.

3. The method for signing, verifying, encrypting and decrypting data and files as claimed in claim 1, wherein the method further comprises:
using a protective access code to prevent the private key from illegal accesses. Optionally set a time interval during which the private key is available without re-entering the protective access code.

4. The method for signing, verifying, encrypting and decrypting data and files as claimed in claim 1, wherein multiple pairs of the private keys and the public keys are generated.

5. A method for signing, verifying, encrypting and decrypting data/files, the method comprising:
installing an execution software in a mobile telecommunication device;
inputting a public key and a private key in pair;
operating the execution software (while working together with an electronic device) to sign, verify, encrypt and decrypt the data/files by using the public key and the private key.

6. The method for signing, verifying, encrypting and decrypting data and files as claimed in claim 5, wherein the mobile telecommunication device is a cell phone.

7. The method for signing, verifying, encrypting and decrypting data and files as claimed in claim 5, wherein the method further comprises:
using a protective code to prevent the private-key from illegal accesses.

8. The method for signing, verifying, encrypting and decrypting data and files as claimed in claim 5, wherein multiple pairs of the private keys and the public keys are generated.

9. The method for signing, verifying, encrypting and decrypting data and files as claimed in claim 5, wherein a verification method of the data and files is to confirm validity of signing to the data and files in an electronic device and comprises steps of:
confirming whether the public key is contained in a signature of the data and files;
if a result is negative, confirming whether the public key is saved in the electronic device;
if the result is negative, further confirming whether the public key is saved in a designated certification authority;
if the result is negative, further inputting a set of identification numbers of the mobile telecommunication device belonged to a signer; or automatically connecting to the mobile telecommunication device of the signer according to properties of the signature;
sending the public key with permission of the signer after the mobile telecommunication device received the request for sending the public key; or selectively automatically sending the public key to the electronic device;
observing the public key in the electronic device; and
checking validity of the signing in the data and files by using the public key.

10. The method for signing, verifying, encrypting and decrypting data and files as claimed in claim 9, wherein the mobile telecommunication device is a cell phone.

11. The method for signing, verifying, encrypting and decrypting data and files as claimed in claim 9, wherein the electronic device is a computer.

12. The method for signing, verifying, encrypting and decrypting data and files as claimed in claim 9, wherein signing data and files comprises a transmission method to connect to the mobile telecommunication device of the signer.

13. The method for signing, verifying, encrypting and decrypting data and files as claimed in claim 5, wherein signing and verification of the data and files are to sign the files with an electronic device and comprise steps of:
confirming whether the private key is contained in the electronic device;
if the result is positive, inputting a protective access code to obtain the private key that is used to sign digest data of the files to achieve the signing;
if the result is negative, further inputting a set of identification numbers of the mobile telecommunication device belonged to a signer;
sending the digest data of the files to the mobile telecommunication device of the signer in order to ask for the signing;
inputting the protective access code to obtain the private key saved in the mobile telecommunication device;
signing the digest data with the private key;
sending the signed digest data to the electronic device; and
completing a digital signature with the electronic device.

14. The method for signing, verifying, encrypting and decrypting data and files as claimed in claim 13, wherein the electronic device can be a computer or a cell phone.

15. The method for signing, verifying, encrypting and decrypting data and files as claimed in claim 13, wherein the mobile telecommunication device is a cell phone.

16. The method for signing, verifying, encrypting and decrypting data and files as claimed in claim 13, wherein the digest data of the files is a digest of the data and files.

17. The method for signing, verifying, encrypting and decrypting data and files as claimed in claim 5, wherein an encryption method of the data and files is to encrypt the files with an electronic device, is only decrypted by a receiver and comprises steps of:
confirming whether one public key of the receiver is contained in the electronic device;
if the result is negative, confirming whether the public key is saved in a certification authority;
if the result is negative, further inputting a set of identification numbers of the mobile telecommunication device belonged to the receiver;
observing a request for the public key in the mobile telecommunication device of the receiver;
sending the public key of the receiver to the electronic device;
observing the public key in the electronic device;
selectively repeating foregoing steps when multiple receivers are included;
generating a password in the electronic device;
encrypting the files by the password; or encrypting certain application-dependent cipher data by the password;
encrypting the password by the public key of the receiver;
combining relative data with the data and files to complete the encryption method.

18. The method for signing, verifying, encrypting and decrypting data and files as claimed in claim 17, wherein the mobile telecommunication device is a cell phone in the encryption method of the files.

19. The method for signing, verifying, encrypting and decrypting data and files as claimed in claim 17, wherein the electronic device is a cell phone in the encryption method of the files.

20. The method for signing, verifying, encrypting and decrypting data and files as claimed in claim 17, wherein the electronic device is a computer in the encryption method of the files.

21. The method for signing, verifying, encrypting and decrypting data and files- as claimed in claim 5, wherein a decryption method of the data and files is to decrypt the encrypted data and files by using the private key with an electronic device and comprises steps of:
confirming whether the private key is saved in the electronic device;
if the result is positive, inputting a protective code to obtain the private key that is used to decrypt an encrypted password in the data and files;
if the result is negative, further inputting a set of identification numbers of the mobile telecommunication device having the private key to the electronic device; or to connect the mobile telecommunication device automatically according to the properties of the public key.
sending a decryption request and the encrypted password;
inputting the protective access code to the mobile telecommunication device to obtain the private key;
using the private key to decrypt the password encrypted by the public key to obtain a decrypted password;
sending the decrypted password to the electronic device;
depending on the actual application, either using the password to decrypt the data and files directly; or using the password to decrypt certain application-depended cipher data which is used to decrypt the data and files.

22. The method for signing, verifying, encrypting and decrypting data and files as claimed in claim 21, wherein the mobile telecommunication device is a cell phone in the decryption method of the files.

23. The method for signing, verifying, encrypting and decrypting data and files mobile files as claimed in claim 21, wherein the electronic device is a cell phone in the decryption method of the files.

24. The method for signing, verifying, encrypting and decrypting mobile files as claimed in claim 21, wherein the electronic device is a computer or computer peripherals in the decryption method of the files.
